(19) United States
(12) Patent Application Publication
(10) Pub. No.: US 2009/0168247 A1
(43) Pub. Date: Jul. 2, 2009

(54) MAGNETIC HEAD WITH EMBEDDED SOLDER CONNECTION AND METHOD FOR MANUFACTURE THEREOF

(76) Inventors: Christian Rene Bonhote, San Jose, CA (US); Jeffrey S. Lille, Sunnyvale, CA (US)

Correspondence Address: ZILKA-KOTAB, PC- HIT, P.O. BOX 721120, SAN JOSE, CA, 95172-1120, US

(21) Appl. No.: 11/966,059

(22) Filed: Dec. 28, 2007

(51) Int. Cl. G11B 5/60

(52) U.S. Cl. 360/234.5

(57) ABSTRACT

A slider for magnetic data recording, the slider including a plurality of solder pads that are embedded into the head. The solder pads can be formed during the formation of read and/or write heads, and can each be contained within a cavity. These cavities can be photolithographically patterned so that they can be formed very close together. In addition, because the solder pads are contained within the cavities, they do not flow into one another as would standard solder balls so that the embedded solder balls can be spaced much more closely together than standard solder balls can, without the risk of shorting between solder pads.

### FIELD OF THE INVENTION

The present invention relates to perpendicular magnetic recording and more particularly to a slider having an embedded solder connection for decreased lead connection spacing.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head can include an electrically conductive write coil that passes through a magnetic yoke. The yoke can be configured with a write pole and one or more return poles. The write pole has a small cross section at the air bearing surface relative to the one or more return poles. When an electrical current flows through the write coil, a resulting magnetic field produces a magnetic flux in the yoke. This magnetic flux results in a write field being emitted from the tip of the write pole. This write field is sufficiently strong to locally magnetize the magnetic medium, thereby writing a bit of data.

The read head can be a magnetoresistive sensor such as a giant magnetoresistive (GMR) sensor or a tunnel valve. A GMR sensor includes a nonmagnetic conductive layer, referred to as a spacer layer, sandwiched between first and second ferromagnetic layers, referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos Θ, where Θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

The read and write heads each have electrical leads for connection to processing circuitry. The read had has a pair of leads that provide a sense current to the sensor, and through which a change in electrical resistance can be read as a signal. The write head has at least first and second leads connected with the write coil for supplying a current to the write coil in order to write data. In addition to the read sensor leads and write head leads, magnetic heads often include additional leads for additional embedded devices or features.

These leads can be connected with the arm electronic by solder ball connections on a surface of the slider. A small molten ball of solder is dropped onto the sensor and write head leads on the surface of the slider in order to connect these sensor and write head leads with electrically conductive lead (such as a flex cable) that extends along the suspension assembly to signal arm electronics circuitry and eventually to other signal processing circuitry.

### SUMMARY OF THE INVENTION

The present invention provides a slider for magnetic data recording, the slider includes a read head and a write head, each of the read and write heads having at least one electrically conductive lead associated therewith. The slider also includes a plurality of solder pads that are embedded into the head.

The solder pads can be formed during the formation of read and/or write heads, and can each be contained within a cavity. These cavities can be photolithographically patterned so that they can be formed very close together. In addition, because the solder pads are contained within the cavities, they do not flow into one another as would standard solder balls so that the embedded solder balls can be spaced much more closely together than standard solder balls can, without the risk of shorting between solder pads.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is a perspective view of a slider according to a possible embodiment of the invention;

FIG. 3 is a cross sectional view of the slider of FIG. 2;

FIG. 4 is a cross sectional view of a slider according to an alternate embodiment of the invention;

FIG. 5 is a cross sectional view of a slider according to an embodiment of the invention, shown in an intermediate stage of manufacture, before a wafer has been cut into rows of sliders;

FIG. 6 is a cross sectional view of a slider according to an embodiment of the invention with an external lead connected to an embedded solder connection; and

FIG. 7 is a cross sectional view of a slider according to another embodiment of the invention with an external lead connected with an embedded solder connection.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

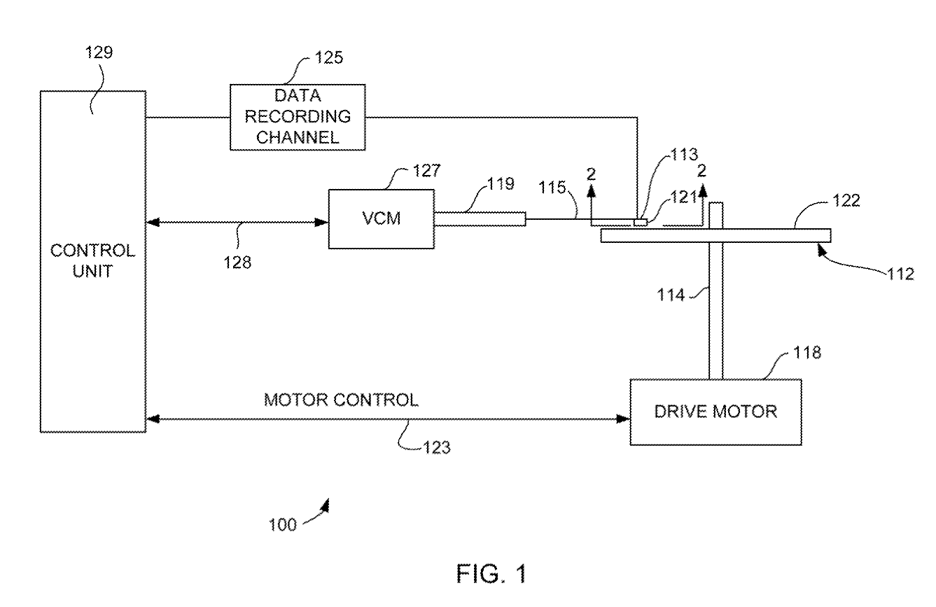

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

The above description of a typical magnetic disk storage system, and the accompanying illustration of FIG. 1 are for representation purposes only. It should be apparent that disk storage systems may contain a large number of disks and actuators, and each actuator may support a number of sliders.

As more devices are integrated into a magnetic slider 113, there is a need for more connections to be made. In addition, the sliders themselves are becoming smaller, leaving less room for such connections. traditionally, connection of a lead has been made to the slider by the application of solder balls. However, these small molten balls of solder used to connect lead circuitry can only be made so small. If the solder balls are spaced too close together, they will flow into one another causing shorts. The present invention overcomes this limitation, allowing lead connections to be located closer together on the slider 113.

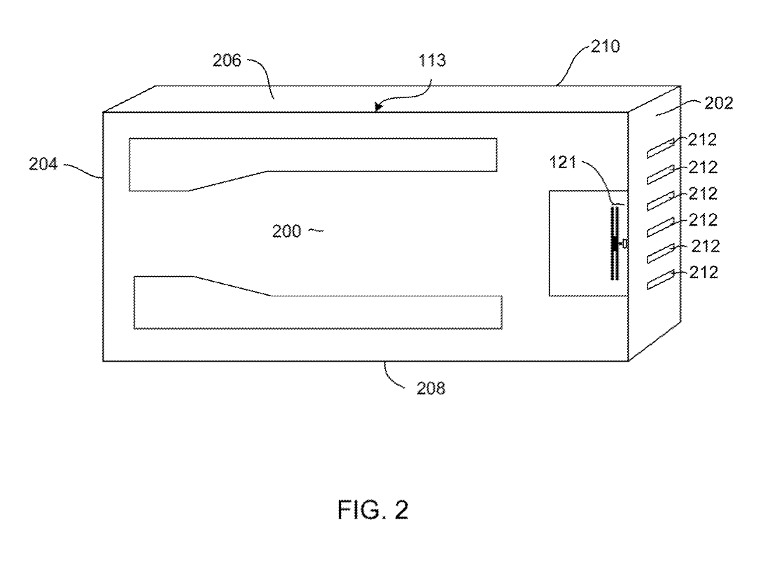

With reference to FIG. 2, the orientation of the magnetic head 121 in a slider 113 can be seen in more detail. FIG. 2 is a perspective view showing the air bearing surface (ABS) 200 of the slider 113, and as can be seen the magnetic head 121 including an inductive write head and a read sensor, is located at a trailing edge of the slider. The slider has a trailing edge surface 202, a leading surface 204 opposite the trailing edge surface 202 and first and second sides 206, 208. The slider also has a side opposite the ABS surface that is referred to as a flex side surface 210, which is into the plane of the page, at the back of the slider 113 as shown in FIG. 2.

With continued reference to FIG. 2, the slider 113 has a plurality of embedded solder pads 212 formed in a surface of the slider 113. Although the embedded solder pads 212 are shown as being exposed at the trailing edge surface 202, they could also be exposed at another surface, such as the flex surface 210.

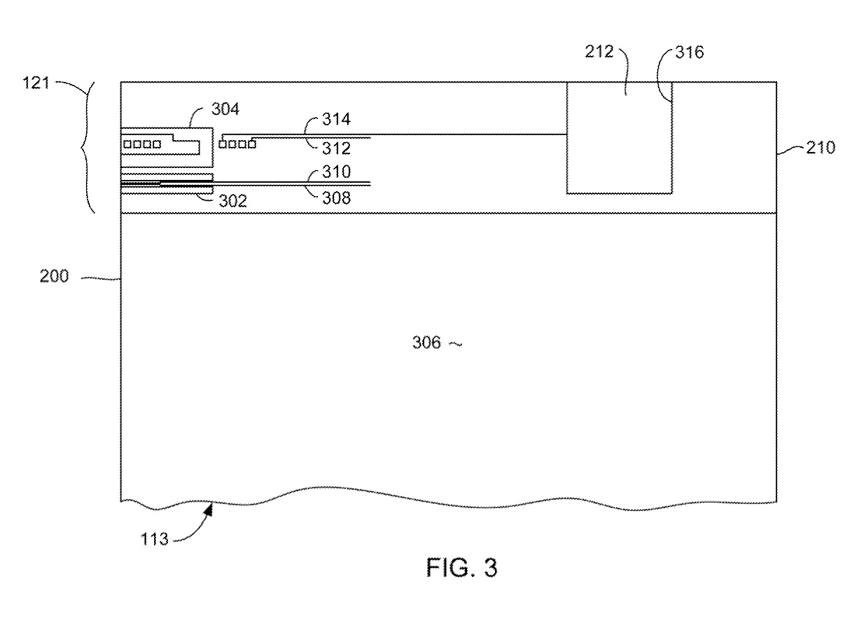

FIG. 3, shows a cross sectional view of a portion of the slider 113. The magnetic head 121 formed on the slider includes a read head 302 and a write head 304. The magnetic head 121 is formed on a slider substrate 306 that is preferably a ceramic such as AlOx, TiC, TiOx, or some similar material. As those skilled in the art will appreciate, the magnetic head 121 is formed through the photolithographic patterning, deposition and etching of various layers such as insulation layers, magnetic layers, electrical coil layers, etc. on the substrate 306.

With continued reference to FIG. 3, one of the embedded solder connections 212 is shown in cross section. Various electrically conductive lead layers 308, 310, 312, 314 are connected with the read and write heads 302, 304. These leads, 308-314 (of which there may be more than those shown) are connected with the embedded solder pads 212 shown in FIG. 2. Because FIG. 3 is a cross sectional view, only one of the embedded solder pads 212 is shown, and only one of the leads 314 is shown connected with the particular embedded solder pad 212. The other leads 308, 310, 312 could turn into or out of the plane of the page to connect with other of the embedded solder pads 212 shown in FIG. 2.

As mentioned above, the embedded solder pads 212 can be formed during fabrication of the read and write heads 302, 304. This can be performed by defining a cavity or opening 316 in the head 121 during the build up of the read and write heads. This cavity 316 can be photolithographically defined, allowing the size and shape to be very accurately controlled down to a very small size and spacing between openings. Then, when the construction of the read and write heads 302, 304 is complete or nearly complete, a solder material can be deposited into the opening, preferably by electroplating. The solder that is deposited into the opening is preferably a lead free solder, and can be, for example, SnAgCu or SnSb.

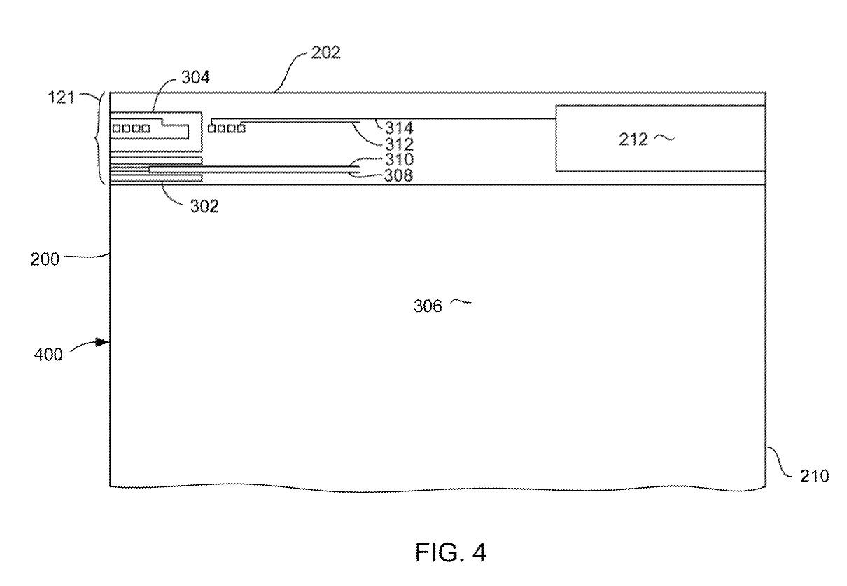

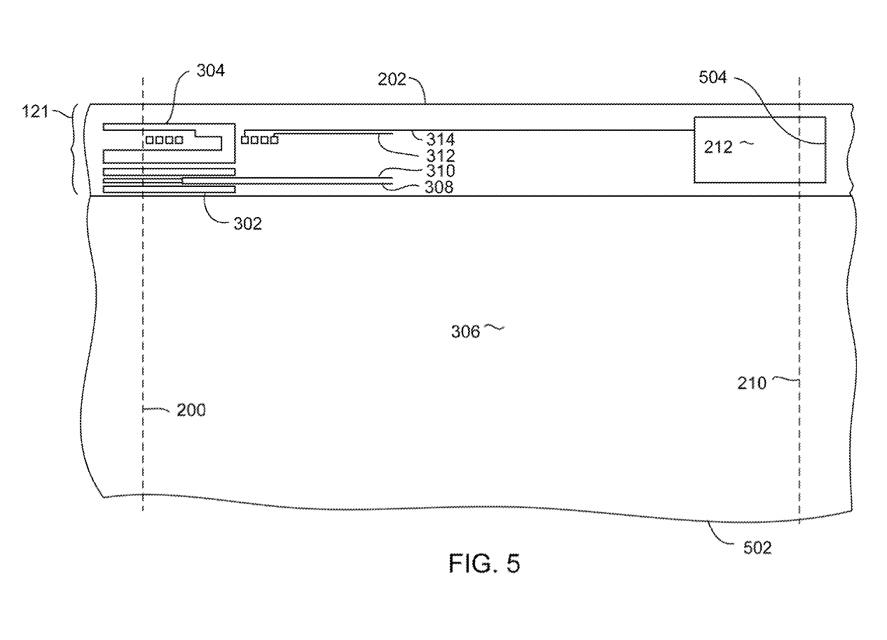

In the above described embodiment, the embedded solder pad 212 extends to the trailing edge surface 202. With reference to FIG. 4, in another embodiment of the invention 400, the embedded solder pad connection 212 can be formed to extend to the flex side surface 210. As those skilled in the art will appreciate, this is the side of the slider 113 that connects with the suspension via the head gimbal assembly (not shown). To construct such a slider 400, the embedded solder pad 212 is formed during the construction of the read and write heads 302, 304. This can be seen more clearly with reference to FIG. 5, which shows a view of a slider formed on a wafer 502. FIG. 5 shows the slider 113 before the wafer 502 has been sliced into rows and lapped to define the air bearing surface 200 and flex side surface 210. The location of the air bearing surface plane 200 and flex side surface plane 210 are both shown by a dashed line in FIG. 5 to indicate that these are the locations at which these surfaces 200, 210 will be located after slicing and lapping of the wafer 502. The lapping operation need only be performed on the ABS side 200. As can be seen then, in this embodiment the embedded solder pad 212 is buried within the build up of the read and write heads 302, 304, but extends slightly beyond the location of the flex surface plane 210. The formation of a cavity 504 and deposition of the solder material into the opening to form the embedded solder pad 212 are performed prior to the complete fabrication of the read and write heads 302, 304, so that the embedded solder pad 212 is recessed from the trailing edge surface 202 (ie. does not extend to the surface 202). However, the embedded solder pad 212 can be formed near the end of the construction of the read and write heads 302, 304. For example, the embedded solder connection 212 may be separated from the trailing edge surface 202 by layer a protective layer, such as alumina, formed over the write head 304.

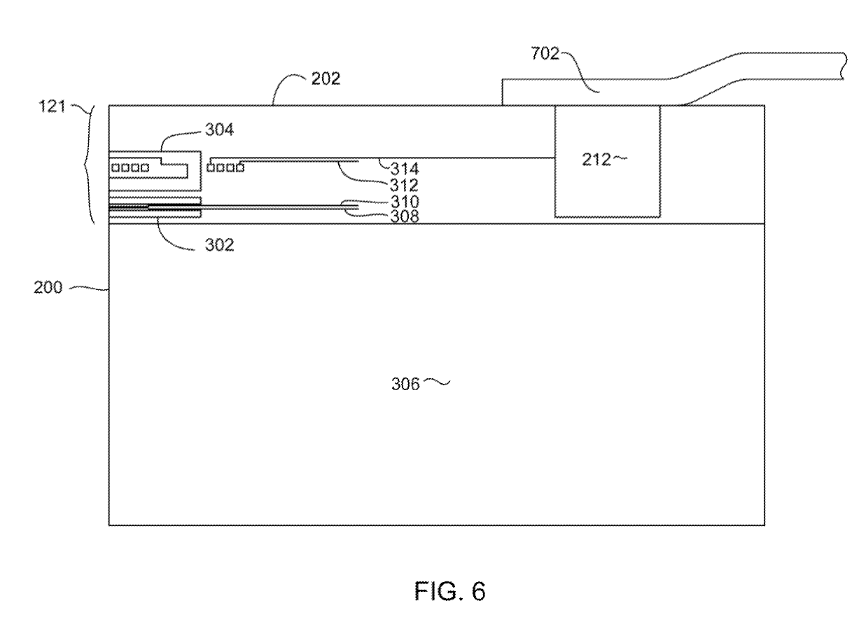

With reference now to FIG. 6, when connection is to be made to the solder pad 212, an external lead wire 702, which can be constructed of a material such as Au, Cu or some other electrically conductive material can be pressed against the solder pad 212. The solder pad can be heated, melting the solder pad and thereby fusing it to the lead 702. Because the solder pad 212 is contained within the photolithographically defined opening, the solder does not flow out over a large area, as would be the case if a standard solder ball were used to make the connection. This very advantageously allows the solder pads 212 and their associated connections to be made very close to one another. This, therefore, allows more leads connections to be made on ever smaller sliders.

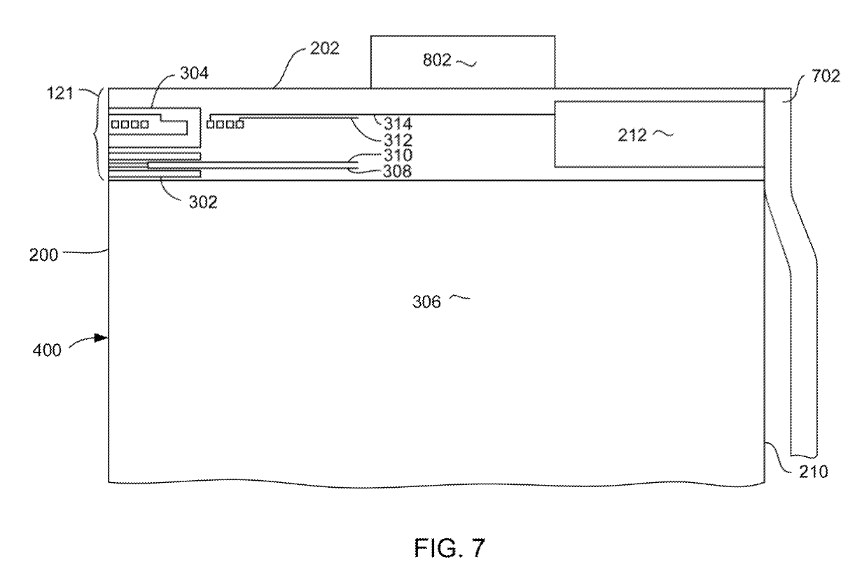

With reference to FIG. 7, the connection of a lead 702 to a flex side exposed solder pad 212 is shown. In addition to the solder pads 212 additional pads, such as a gold pad 802 can be provided at the trailing edge surface 202 to allow wafer level testing of the read and write heads 302, 304 to be performed (prior to slicing and lapping of the wafer to form the slider 113).

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A slider for magnetic data recording, comprising
a slider body;
a head formed on the slider body, the head including a read sensor and a write head, each of the read sensor and write head having at least one lead connected therewith; and
a plurality of solder pads embedded within the head.

2. A slider as in claim 1 wherein where each of the solder pads is electrically connected with one of the leads.

3. A slider as in claim 1 wherein the slider has a trailing surface, and wherein at least on of the plurality of solder pads is exposed at the trailing surface.

4. A slider as in claim 1 wherein the slider has an air bearing surface and a flex side surface opposite the air bearing surface and wherein the solder pad has is exposed at the flex side surface.

5. A slider as in claim 1 wherein the solder pad comprises a tin alloy.

6. A slider as in claim 1 further comprising an external lead wire and wherein the solder pad is fused to the external lead wire.

7. A slider as in claim 1 further comprising a cavity formed in the head, and wherein the solder pad is contained within the opening.

8. A slider as in claim 7 wherein the cavity is photolithographically defined.

9. A slider as in claim 7 wherein the write head is constructed at a build elevation within the head and wherein the embedded solder pad is contained within a cavity formed within the head, the cavity extending at least to depth that is at least the level of the build elevation of the write head.

10. A slider as in claim 1 wherein slider has an air bearing surface, a flex side surface opposite the air bearing surface, and a trailing edge surface extending from the air bearing surface, and wherein the solder pad is exposed at the flex side surface, the slider further comprising a wafer level testing contact pad formed on the trailing edge surface.

11. A method for manufacturing a slider for magnetic data recording, comprising:
providing a wafer;
forming a read head on the wafer;
forming a write head on the wafer;
forming a cavity; and
depositing a solder material into the cavity.

12. A method as in claim 11 wherein the forming a cavity further comprises photolithographically patterning a mask structure having an opening configured to define a cavity, and performing an etching to remove material not protected by the mask structure to form the cavity.

13. A method as in claim 11 wherein the cavity is formed simultaneously with the forming of the write head.

14. A method as in claim 11 wherein the cavity is formed simultaneously with the forming of the read head and write head.

15. A method as in claim 11 wherein the depositing the solder material into the cavity comprises electroplating.

16. A method as in claim 11 wherein the depositing the solder material into the cavity comprises electroplating a tin alloy.

17. A method as in claim 11 wherein the cavity is formed to extend through a flex side surface plane of the slider.

18. A method as in claim 11 wherein the cavity is formed to open up through a trailing edge surface of the slider.

19. A method as in claim 11 wherein the cavity is formed to extend through a flex side surface plane of the slider, the method further comprising forming an electrically conductive contact pad on a trailing edge surface of the slider, the electrically conductive pad providing electrical connection to either of the read head or write head for wafer level testing.

20. A method as in claim 11 further wherein the cavity is formed to extend across a flex side surface plane, the method further comprising:
slicing the wafer along the flex side surface plane.

21. A method as in claim 11 further wherein the cavity is formed to extend across a flex side surface plane, the method further comprising:
slicing the wafer along the flex side surface plane, to form a flex side surface; and
forming an oxide layer over an exposed portion of the deposited solder material at the flex side surface.

22. A magnetic data recording system, comprising:
a housing;
a magnetic medium rotatably mounted within the housing;
an actuator mounted within the housing;
a suspension connected with the actuator;
a slider connected with the suspension, the slider further comprising:
a slider for magnetic data recording, comprising
a slider body;
a head formed on the slider body, the head including a read sensor and a write head, each of the read sensor and write head having at least one lead connected therewith; and
a plurality of solder pads embedded within the head.

23. A magnetic data recording system as in claim 22 wherein where each of the solder pads is electrically connected with one of the leads.
